(19) United States
(12) Patent Application Publication
(10) Pub. No.: US 2005/0188040 A1
(43) Pub. Date: Aug. 25, 2005

(54) Electronic message management system with entity risk classification

(75) Inventors: James Kott, Kirkland, WA (US); David L. Weld JR., Seattle, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: MessageGate, Inc.

(21) Appl. No.: 11/048,971

(22) Filed: Feb. 2, 2005

Related U.S. Application Data
(60) Provisional application No. 60/540,997, filed on Feb. 2, 2004.

(51) Int. Cl. G06F 15/16

(52) U.S. Cl. 709/206

(57) ABSTRACT

An electronic message management system, including a risk assessment engine to assess risks associated with accepting messages from a number of tracked entities, such as senders, servers, and so forth, is described.

### RELATED APPLICATIONS

The present application is a non-provisional application of provisional application 60/540,997, entitled “Multi-class Messaging and Trusted Senders”, filed on Feb. 2, 2004. The present application claims priority to said provisional application, and incorporates its specifications by reference, to the extent the '997 specification is consistent with the specification of this non-provisional application.

### TECHNICAL FIELD

Embodiments of the present invention relate generally, but not limited to, the fields of data processing and data communication. In particular, embodiments of the present invention relate to the control of electronic messages, e.g. offensive electronic messages, including employment of entity risk classification.

### BACKGROUND

With advances in computing and networking technology, electronic messaging, such as email, has become ubiquitous. It is used for personal as well as business communication. However, in recent years, the effectiveness of electronic messaging is undermined due to the rise and proliferation of spam mails and viruses.

Large enterprises, such as multi-national corporations, handle millions of electronic messages each day, employing multiple geographically dispersed servers, to serve their far flung constituent clients. The problem of unwelcome or undesirable electronic messages is especially difficult for them, and creates a significant hurdle to prioritizing important business communications ahead of unsolicited, unwelcome messages.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of an electronic message management system, suitable for practicing the invention, in accordance with some embodiments;

FIG. 2 illustrates the mail management server of FIG. 1 in further detail, in accordance with some embodiments;

FIG. 3 illustrates a boundary mail server of FIG. 1 in further detail, in accordance with some embodiments;

FIG. 4 illustrates the operational flow between an extemal/internal mail sender and a boundary mail server, in accordance with some embodiments;

FIG. 5 illustrates an example data organization suitable for use to practice the present invention, in accordance with some embodiments;

FIG. 6 illustrates a portion of the operational flow of the tracker of FIG. 3, in accordance with some embodiments;

FIG. 7 illustrates a portion of the operational flow of the feedback processor of FIG. 2, in accordance with some embodiments; and

FIG. 8 illustrates a portion of the operational flow of risk assessment and classification engine of FIG. 2, in accordance with some embodiments.

### DETAILED DESCRIPTION OF ILLUSTRATIVE EMBODIMENTS

Illustrative embodiments of the present invention include, but are not limited to, an electronic message management system, including e.g. a central mail management server, and a number of boundary mail servers, adapted to manage electronic messages, including the employment of entity risk classification (or contributing to).

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

The phrase “in one embodiment” is used repeatedly. The phrase generally does not refer to the same embodiment; however, it may. The terms “comprising”, “having” and “including” are synonymous, unless the context dictates otherwise. The term “server” may be a hardware or a software implementation, unless the context clearly indicates one implementation over the other.

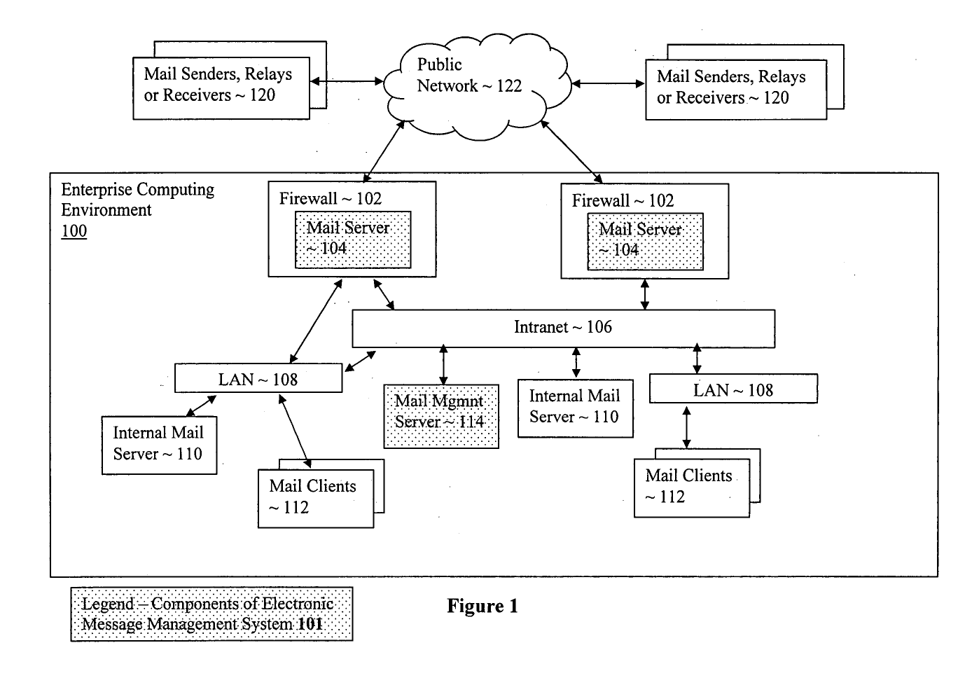

Referring now to FIG. 1, wherein an overview of an electronic message management system, in accordance with some embodiments, is shown. As will be apparent to those skilled in the art, the electronic message management system is particularly suitable for large enterprises, handling millions of electronic messages per day, utilizing numerous geographically dispersed servers. Since electronic mail is the most predominant form of electronic messages, for ease of understanding, the remaining descriptions will primary be presented in the context of electronic mail management. However, one skilled in the art will appreciate that the present invention may be practiced to manage all types of electronic messages, including but are not limited to electronic mails. Further, the present invention may be practiced in computing environment having other architectures.

As illustrated, for the embodiments, electronic message management system 101 includes a central mail management server 114 and a number of distributed mail servers 104. For the embodiments, distributed mail servers 104 are placed on a number of devices, such as firewalls 102, located at a number of boundary points of enterprise computing environment 100. In alternate embodiments, the mail servers need not be placed on the same machine as the firewall. The firewall machines may sit on separate hardware from the mail servers, just in front of them and modulating access to them by servers outside the enterprise computing environment 100. The zone into which the perimeter mail servers are placed is usually called a “DMZ” (demilitarized zone), and is typically reserved for those few boundary servers (e.g. email, http, etc.) that need to provide network services that connect directly to external clients on the Internet (e.g. email senders, web browsers, etc.). Accordingly, distributed mail servers 104, whether it is placed directly on the same hardware with the firewall, or on separate hardware behind the firewall, in a DMZ, may also be referred to as boundary mail servers 104. Further, for the embodiments, boundary mail servers 104 are operatively coupled to central mail management server 114, through e.g. Intranet fabric 106. Intranet fabric 106 represents a collection of one or more networking devices, such as routers, switches and the like, to provide the operative coupling between boundary mail servers 104 and mail management server 114.

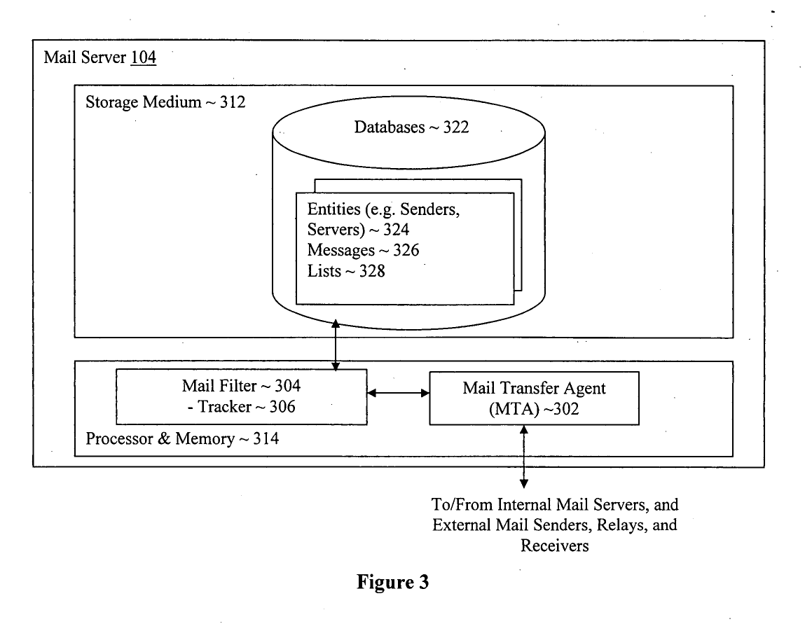

As will be described in more detail below, in various embodiments, boundary mail server 104 includes a mail transfer agent (MTA) component 302 and a mail filter component 304 (FIG. 3). In particular, MTA 302 is adapted to receive emails from electronic mail senders (which may be outside or within enterprise computing environment 100) using e.g. the Simple Mail Transfer Protocol (SMTP) and its extensions defined by the Internet Engineering Task Force (IETF) in [RFC2822] and related specifications, and mail filter component 304 is adapted to determine, and instruct MTA 302 on whether the received mails are to be accepted or rejected. Further, mail filter 304 is adapted to make the determination efficiently and consistently across enterprise computing environment 100, in accordance with the enterprise's email management policies. Still further, central mail management server 114 is employed to centrally manage the enterprise's electronic mail management policies. An example of a suitable MTA is Sendmail, available from Sendmail, Inc. of Emeryville, Calif., in particular, versions that support the Milter Application Programming Interface.

Continue to refer to FIG. 1, enterprise computing environment 100 is coupled to the external world, e.g. to various external mail senders, relays or receivers 120, through public network 122. External mail senders, relays or receivers 120 represent a broad range of these elements known in the art. Public network 122 may comprise one or more interconnected public networks, including but are not limited to the famous Internet.

Within enterprise computing environment 100, firewall 102 (including mail server 104 are coupled to other internal servers, such as the earlier described mail management server 114 and internal mail servers 110, and mail clients 112, through a number of internal networks, including but not limited to intranet 106 and local area networks 108.

In various embodiments, one of the internal servers, e.g. mail management server 114, may also be used as an analysis server, to facilitate analysis of various suspicious electronic mails by administrators of enterprise computing environment 100.

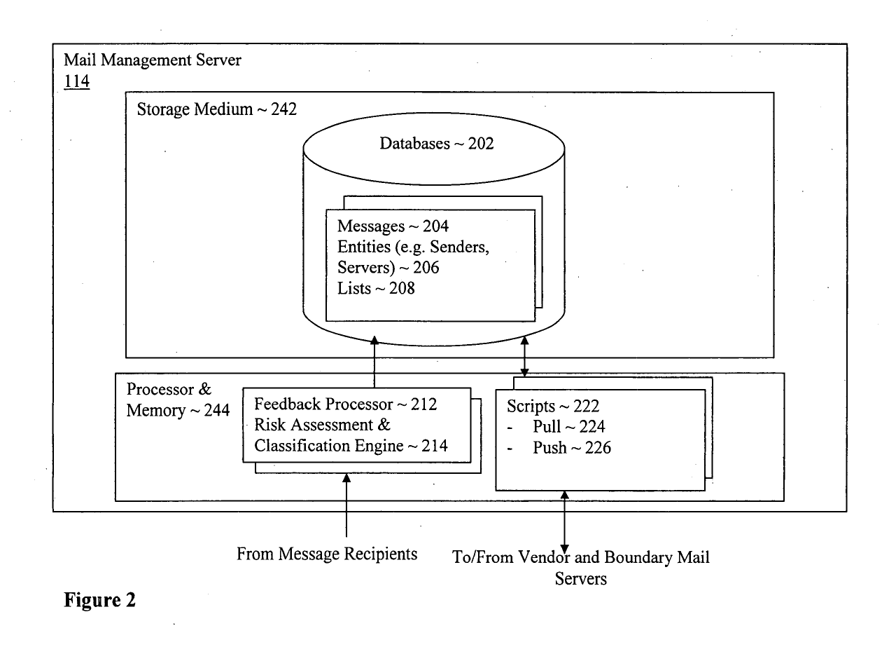

Referring now to FIG. 2, wherein mail management server 114 is illustrated in further detail, in accordance with various embodiments. As illustrated, for the embodiments, mail management server 114 includes one or more management databases 202 having stored therein among other things, records 204 of messages handled by the electronic message management system, and records 206 of entities associated with these messages. Additionally, for the embodiments, management databases 202 further have stored therein lists 208, within which the entities are organized, in accordance with the corresponding risks perceived for accepting electronic messages from these entities.

24 The term “entities” as used herein refer to any entities (of interest) associated with the messages handled by the system, including in particular, but are not limited to, senders of the messages, and servers involved in the originating and forwarding of the messages to the system. Of course, senders of the messages may include, but are not limited to, individual senders, business partners (domain), mailing lists, and so forth. In alternate embodiments, more or less message associated entities may be tracked and/or risk classified. In some embodiments, the message associated entities that get risk classified may be less than the message associated entities tracked.

In various embodiments, lists 208 may include a white list and a black list. For these embodiments, membership with the white list denotes the risk perceived to be within an acceptable low level. Accordingly, messages associated with members of the white list may e.g. be automatically accepted (or alternatively, automatically accepted unless other dangerous signs are present). Similarly, membership with the black list denotes the risk perceived to be above an unacceptable high level. Accordingly, messages associated with members of the black list may e.g. be automatically rejected (or alternatively, automatically rejected unless other mitigating signs are present).

In various embodiments, lists 208 further include a green list. For these embodiments, membership with the green list denotes the risk perceived to be relatively low, but not necessarily below the acceptable low level. Accordingly, messages associated with members of the green list may e.g. be biased for acceptance, subject to one or more additional confirmation analysis, when considering for acceptance or rejection.

In various embodiments, lists 208 further include a yellow list. For these embodiments, membership with the yellow list denotes the risk perceived to be relatively high, but not necessarily higher than the unacceptable high level. Accordingly, messages associated with members of the yellow list may e.g. be biased for rejection, subject to one or more additional rebuttal analysis, when considering for acceptance or rejection.

Of course, in various embodiments, more less lists may be employed, and the risk levels separating the various lists are application dependent, and may vary from implementation to implementation.

Still referring to FIG. 2, for the illustrated embodiments, mail management server 114 also includes feedback processor 212 adapted to facilitate recipients of messages to provide feedback on the messages, e.g. whether the messages are spam or not spam. In various embodiments, feedback of finer granularity, such as solicitation, pornography, etc may be employed also. Further, the messages may also be automatically classified, e.g. by filter 304 (FIG. 3). For these embodiments, the recipients' feedback may augment or override the automatic classifications.

Additionally, for the illustrated embodiments, mail management server 114 also includes risk assessment and classification engine 214 adapted to assess the risk associated with accepting a message associated with a tracked entity. Further, risk assessment and classification engine 214 is adapted to organize and enroll the tracked entities as members of lists 208, based at least in part on their assessed risks.

For the illustrated embodiments, mail management server 114 also includes a number of scripts 222, including pull script 224 and push script 226. The former, i.e. pull script 224, is adapted to facilitate pulling of message handling information from boundary mail servers 104, including creation of the above described tracked entities and message records 204 and 206, based on the message handling information pulled. Whereas, the latter, i.e. push script 226, is adapted to facilitate pushing of the most current version of lists 208 onto boundary mail servers 104 for use to manage message ingress. The arrangement allows boundary mail servers 104 to operate more efficiently, without having to access mail management server 114 across the enterprise's internal network during operation.

In alternate embodiments, in lieu of the pull and push script 224-226, scripts adapted to “push” message handling information onto mail management server 114, and “pull” the current version of lists 208 from mail management server 114 may be provided to the boundary mail servers 104 instead.

Continuing to refer to FIG. 2, for the illustrated embodiments, mail management server 114 further includes one or more persistent storage units (storage medium) 242, employed to stored management databases 202. Further, mail management server 114 includes one or more processors and associated non-persistent storage (such as random access memory) 244, coupled to storage medium 242, to execute feedback processor 212, risk assessment and classification engine 214, and scripts 222. For these embodiments, feedback processor 212 and risk assessment and classification engine 214 are implemented in software. In alternate embodiments, feedback processor 212 and risk assessment and classification engine 214 may be implemented in hardware, in part or in whole.

Referring now to FIG. 3, wherein a boundary mail server 104 is illustrated in further detail, in accordance to various embodiments. As alluded to earlier, mail server 104 includes a local version 322 of management databases 202. For the illustrated embodiments, local version 322 of management database includes messages handled 326, tracked entities 324 extracted from the messages handled, and lists 328 received from mail management server 114.

Further, for the embodiments, mail server 104 includes MTA 302 and mail filter 304. As described earlier, MTA 302 is adapted to send and receive electronic mails to and from other mail senders/receivers or relays 120/110 (internal or external to enterprise computing environment 100), and mail filter 304 is adapted to determine whether a received electronic mail is to be accepted or rejected. For the embodiments, mail filter 304 employs lists 328 when performing the acceptance and rejection determination. In various embodiments, mail filter 304 may also employ other tools, when performing the acceptance and rejection determination, including but not limited to the header analysis technique described in co-pending application Ser. No. 11/036,916, filed on Jan. 14, 2005.

For the illustrated embodiments, mail filter 304 further includes tracker 306 for extracting and tracking entities associated with messages, allowing the tracking operation to be integrally performed as part of the filtering process. As described earlier, the tracked entities may be individual senders, business partners (domain), mailing lists, and so forth.

For the embodiments, mail server 104 also includes one or more persistent storage units (or storage media) 312, employed to stored management databases 202 and management data structures 212. Further, mail server 104 includes one or more processors and associated non-persistent storage (such as random access memory) 314, coupled to storage medium 312, to execute MTA 302 and mail filter 304. For these embodiments, MTA 302 and mail filter 304 (including tracker 306) are implemented in software. In alternate embodiments, MTA 302 and mail filter 304 (including tracker 306) may be implemented in hardware, in part or in whole.

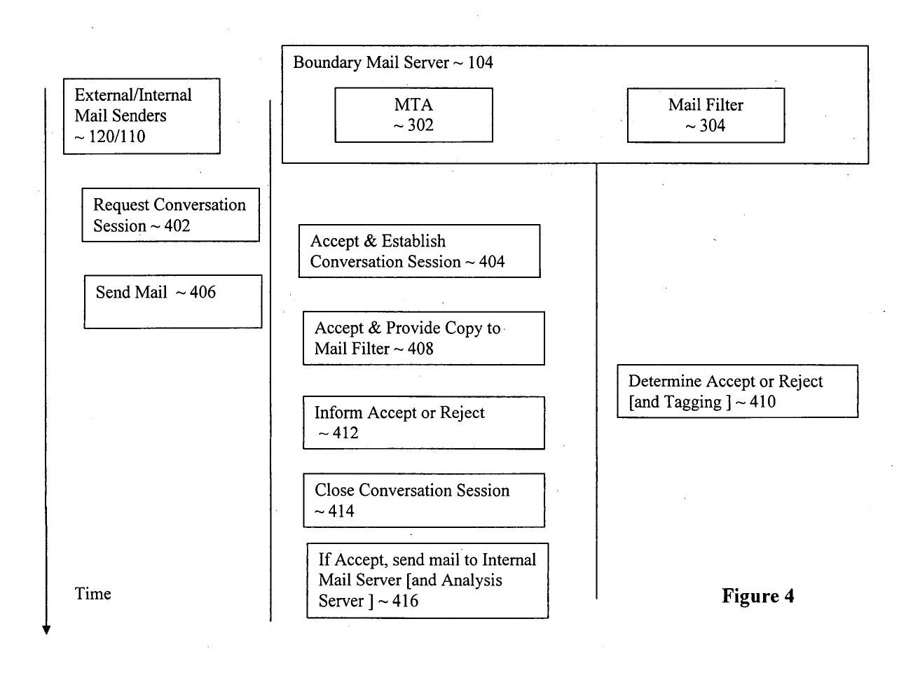

Referring now to FIG. 4, wherein the operational flow of an external/internal mail sender 120/110 and a boundary mail server 104, in accordance to various embodiments, is shown. As illustrated, for the embodiments, the operations start with mail sender 120/110 requesting MTA 302 of the boundary mail server 104 to establish a conversation session, op 402. In response, MTA 302 accepts and establishes the conversation session, op 404.

Next, mail sender 120/110 sends the electronic mail through the conversation session, op 406, and MTA 302 accepts the electronic mail, and provides a copy of the received electronic mail to mail filter 304, to determine whether the electronic mail is to be accepted or rejected, op 408.

In response, mail filter 304 analyzes the electronic mail, employing lists 328 (and optionally, other analysis tools), as earlier described, op 410. Mail filter 304 characterizes the electronic mail, based at least in part on the result of the analysis, and makes an accept/reject determination for the electronic mail, op 410. In various embodiments, if a sender is of sufficient high risk per lists 328, mail filter 304 rejects the electronic mail, regardless of whether servers associated with the electronic mail are high risk or not. Likewise, in various embodiments, if a server associated with an electronic mail is of sufficient high risk per lists 328, mail filter 304 rejects the electronic mail, regardless of whether the sender and other servers associated with the electronic mail are high risk or not. In other embodiments, other acceptance/rejection criteria may be employed, i.e. they may vary from implementation to implementation.

Additionally, for the illustrated embodiments, mail filter 304 further invokes tracker 306 to integrally perform the entity tracking operation, as described earlier. Operation of tracker 306 will be further described below.

Still referring to FIG. 4, for the illustrated embodiments, if analysis by an analyst or administrator is supported, mail filter 304 may further instruct MTA 302 to re-reroute or send an extra copy of the electronic mail to the analysis server (which may be the central management server 114). Thereafter, based on the determination results returned, including instructions, if any, MTA 302 informs mail sender 120/110 whether the electronic mail is accepted or rejected, op 412. Thereafter, MTA 302 closes the conversation session, op 414. In other words, for the embodiments, the accept/reject determination is performed during the conversation session, prior to its termination. The approach may have the advantage of ensuring an unwelcome or undesirable mail sender is aware of the rejection, potentially causing the unwelcome or undesirable mail sender to remove the recipient(s) from its recipient list.

If the electronic mail is to be accepted, MTA 302 forwards the electronic mail to the appropriate internal mail server 110, op 416. Further, if instructed, MTA 302 further sends a copy of the electronic message to an analysis server, e.g. mail management server 114, op 416.

In various embodiments, the electronic mail is provided from mail sender 120/110 to MTA 302 in parts, in particular, first an identification of the sender, followed by identifications of the recipients, and then the body of the electronic mail, and MTA 302 invokes mail filter 304 to determine acceptance or rejection of the electronic mail for each part. In other words, the electronic mail may be rejected after receiving only the identification of the sender, or after receiving identifications of the recipients, without waiting for the entire electronic mail to be provided. Again, the approach may have the advantage of efficient operation.

In alternate embodiments, the filtering operation, including the employment of lists 208, may be practiced after the entire electronic message has been received. In particular, lists 208 may be employed for an initial pass to determine whether to accept the electronic messages or subject them to additional analysis, thereby allowing decisions to accept electronic messages from trusted/proper entities more efficiently made.

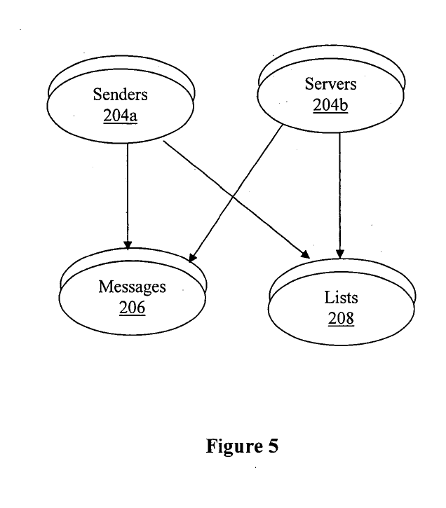

Having now described an example environment for practicing the present invention, we refer now to FIGS. 5-8 to further describe tracker 306, feedback processor 212 and risk assessment and classification engine 214, more specifically, the relevant portions of their operational flow.

FIG. 5 is an example data organization suitable for use to practice embodiments of the present invention, in accordance with some embodiments. As illustrated, data associated with the tracked entities, such as identities or other attributes of the senders and servers, are organized as sender and server data objects 502 and 504. Similarly, data associated with the messages handled, and the various entity lists (of varying perceived risks), are organized as message and list data objects 506 and 508.

Each of the data objects 502-508 includes appropriate pointers associating the data objects, i.e. associating tracked entities (senders and servers) with messages handled, and vice versa, as well as associating tracked entities (senders and servers) with the various lists of (of varying perceived risks).

In alternate embodiments, other data structure and/or organization may be employed instead.

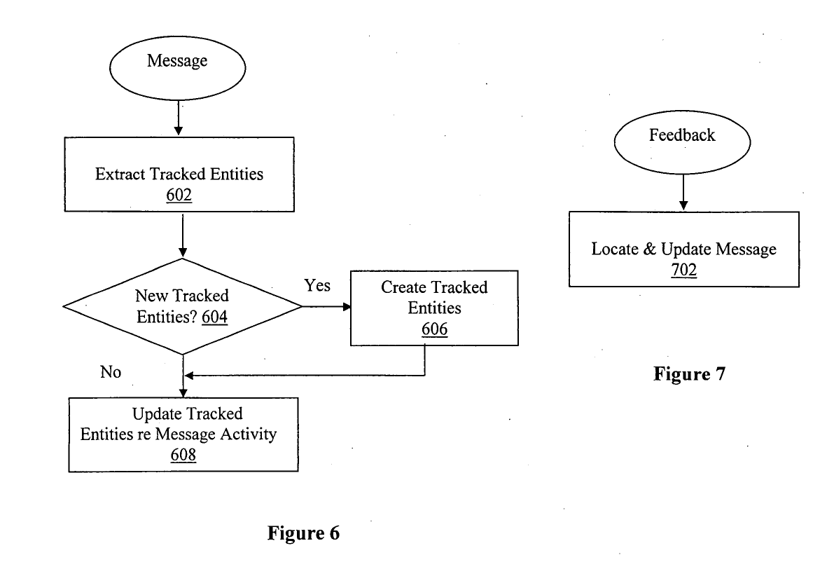

FIG. 6 illustrates a portion of the operational flow of tracker 306, in accordance with some embodiments. As illustrated, on receipt of a message, tracker 306 parses the message for tracked entities, e.g. its sender, handling servers, and so forth, block 602. On extraction of the tracked entities, tracker 306 determines whether it encounters these entities for the first time, i.e. one or more of these entities are new entities, block 604. If so, tracker 306 creates a record for each of the new entities, block 606. Thereafter, or earlier determined there are no new entities, tracker 306 proceeds to update message activity information associated with the tracked entities, block 608.

For the illustrated embodiments, the message activity information includes at least the messages the entities are associated with. In various embodiments, message activity information may also include the number of recipients addressed, the frequency of addressing these recipients, the average size of the messages, and other metrics of the like.

FIG. 7 illustrates a portion of the operational flow of feedback processor 212, in accordance with some embodiments. As illustrated, on receipt of a feedback from a message recipient, feedback processor 212 updates the appropriate message record with the feedback, block 702. As described earlier, the feedback may include, but are not limited to, whether the message is a spam or not a spam message. As described earlier, in other embodiments, finer granularity of feedback may be employed instead. In various embodiments, feedback processor 212 may offer any one of a number of end user interface for a recipient to provide the feedback, including but are not limited to, a web based graphical end user interface.

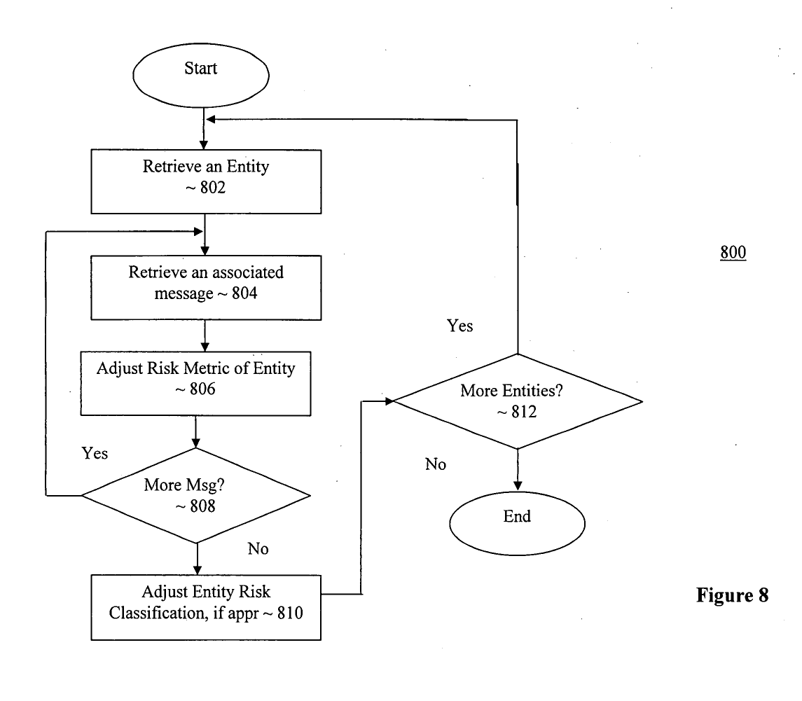

FIG. 8 illustrates a portion of the operational flow of risk assessment and classification engine 214, in accordance with some embodiments. As illustrated, on invocation, which may be periodically, engine 214 retrieves a tracked entity, block 802. On retrieval of a tracked entity, engine 214 retrieves and processes all previously unprocessed message records of the tracked entity, blocks 804-808. For each previously unprocessed message record, engine 214 examines the characterization, if any, attributed to the message by its recipient(s) or filter 304, blocks 804-806. For the embodiments, engine 214 updates a risk metric associated with the entity, based at least in part on the characterization, block 806. For example, engine 214 may negatively adjust the risk metric (i.e. having risk metric indicates higher risk), if a negative characterization is attributed to the message. In various embodiments, the negative adjustment may be linearly or non-linearly proportional to the degree of negative characterization. In various embodiments, engine 214 may positively adjust the risk metric (i.e. having risk metric indicates lower risk), if a positive characterization is attributed to the message. The process is repeated for all previously unprocessed messages, blocks 804-808.

For the embodiments, after all messages have been processed for a tracked entity, block 808, engine 214 determines a risk classification for the tracked entity, block 810. In various embodiments, engine 214 determines the risk classification based on the risk metric associated with the tracked entity. For the embodiments, upon determining the appropriate risk classification, engine 214 enrolls the tracked entity as a member of an appropriate one of lists 208 accordingly, block 810, if the tracked entity is a tracked entity being classified for the first time. For tracked entity having been previously classified, engine 214 may de-enroll and re-enroll the tracked entity accordingly. For example, if the risk metric begins to indicate a sufficiently higher degree of risk, engine 214 may move the tracked entity from e.g. the earlier described example green list, to the earlier described example yellow list. Similarly, if the risk metric begins to indicate a sufficiently lower degree of risk, engine 214 may move the tracked entity from e.g. the earlier described example yellow list, to the earlier described example green list.

The process 800 is repeated for each tracked entity.

Accordingly, the electronic message management system 101 is particular suitable for managing unwelcome or undesirable electronic messages for an enterprise computing environment 100. System 101 enables the enterprise to manage the policies for electronic message management from a central location, which in turn enables the enterprise to manage electronic message acceptance/rejection uniformly, even if their equipment is geographically dispersed. Further, system 101 enables unwelcome or undesirable electronic messages to be rejected outright, lessening wasteful network traffic on the internal network. Still further, system 101 enables the acceptance/rejection determination to be more efficiently and reliably performed, with the employment of entity risk classification.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

1. An electronic message management system comprising:
a plurality of characterizations for electronic messages associated with at least one of senders and servers of the electronic messages, the senders being senders of the electronic messages, and the servers being servers participated in forwarding the electronic messages to the electronic message management system; and
an engine adapted to rate the at least one of senders and severs for risk, based at least in part on the characterizations of the associated electronic messages, if their associated electronic messages are accepted.

2. The system of claim 1, wherein the system further comprises a processor adapted to process and associate recipient feedback for the electronic messages associated with the at least one of senders and servers of the electronic messages.

3. The system of claim 2, wherein the system further comprises a tracker adapted to track the at least one of senders and servers, including their electronic message activities.

4. The system of claim 3, wherein the tracker is adapted to track both senders and servers associated with electronic messages; the processor is adapted to process and associate recipient feedback for the electronic messages with the senders and servers; and the engine is adapted to rate the senders and severs for risk if their associated electronic messages are accepted.

5. The system of claim 1, wherein the system further comprises a tracker adapted to track the at least one of senders and servers, including their electronic message activities. [Note, this is not a duplicate of claim 3, b/c it depends off claim 1 instead.]

6. The system of claim 5, wherein the system further comprises a filter adapted to filter unwanted electronic messages, the filter comprising said tracker.

7. The system of claim 1, wherein the engine is adapted to negatively adjust corresponding risk scores of the senders and servers, in response to negative recipient feedback received for the electronic messages, the senders and senders are associated with.

8. The system of claim 1, wherein the engine is further adapted to enroll the at least one of senders and servers as members of a plurality of lists of varying degrees of risk.

9. The system of claim 8, wherein the lists comprise a list which membership denotes that electronic messages associated with its members are to have a bias for rejection, when considering acceptance or rejection.

10. The system of claim 8, wherein the lists comprise a list which membership denotes that electronic messages associated with its members are to have a bias for acceptance, when considering acceptance or rejection.

11. The system of claim 8, wherein the lists comprise
a first list which membership denotes that electronic messages associated with its members are to be rejected, when considering acceptance or rejection;
a second list which membership denotes that electronic messages associated with its members are to be biased for rejection, when considering acceptance or rejection;
a third list which membership denotes that electronic messages associated with its members are to be bias for acceptance, when considering acceptance or rejection; and
a fourth list which membership denotes that electronic messages associated with its members are to be accepted, when considering acceptance or rejection.

12. A method of operation on an electronic message management, comprising:
storing a plurality of characterizations for electronic messages associated with at least one of senders and servers of the electronic messages, the senders being senders of the electronic messages, and the servers being servers participated in forwarding the electronic messages to the electronic message management system; and
rating the at least one of senders and severs for risk if their associated electronic messages are accepted.

13. The method of claim 12, wherein the method further comprises processing and associating recipient feedback for the electronic messages associated with the at least one of senders and servers of the electronic messages.

14. The method of claim 13, wherein the method further comprises tracking the at least one of senders and servers, including their electronic message activities.

15. The system of claim 14, wherein said tracking comprises tracking both senders and servers associated with electronic messages; said processing and associating comprises processing and associating recipient feedback for the electronic messages with the senders and servers; and said rating comprises rating the senders and severs for risk if their associated electronic messages are accepted.

16. The method of claim 12, wherein the method further comprises tracking the at least one of senders and servers, including their electronic message activities.

17. The method of claim 12, wherein the method further comprises filtering the electronic messages for unwanted electronic messages, and said tracking is performed as an integral part of said filtering.

18. The method of claim 12, wherein said rating comprises negatively adjusting corresponding risk scores of the senders and servers, in response to negative recipient feedback received for the electronic messages, the senders and senders are associated with.

19. The method of claim 12, wherein the method further comprises enrolling the at least one of senders and servers as members of a plurality of lists of varying degrees of risk.

20. The method of claim 19, wherein said enrolling comprises enrolling some of the at least one of senders and servers as members of a list which membership denotes that electronic messages associated with its members are to have a bias for rejection, when considering acceptance or rejection.

21. The method of claim 19, wherein said enrolling comprises enrolling some of the at least one of senders and servers as members of a list which membership denotes that electronic messages associated with its members are to have a bias for acceptance, when considering acceptance or rejection.

22. The method of claim 19, wherein said enrolling comprises enrolling some of the at least one of senders and servers as members of one or more of
a first list which membership denotes that electronic messages associated with its members are to be rejected, when considering acceptance or rejection;
a second list which membership denotes that electronic messages associated with its members are to be biased for rejection, when considering acceptance or rejection;
a third list which membership denotes that electronic messages associated with its members are to be bias for acceptance, when considering acceptance or rejection; and
a fourth list which membership denotes that electronic messages associated with its members are to be accepted, when considering acceptance or rejection.

23. An electronic message management system comprising:
a boundary mail server including a tracker adapted to extract and track at least one of senders and servers associated with electronic messages received by the electronic message management system through the boundary mail server; and
a mail management server coupled to the boundary mail server including a risk assessment engine adapted to assess risks associated with accepting messages associated with the tracked at least one of senders and servers.

24. The system of claim 23, wherein the mail management server further comprises a processor adapted to process and associate recipient feedback for the electronic messages associated with the at least one of senders and servers of the electronic messages.

25. The system of claim 23, wherein the engine is further adapted to enroll the tracked at least one of senders and servers as members of a plurality of lists of varying degrees of risk.
